(19) United States
(12) Patent Application Publication
(10) Pub. No.: US 2016/0152118 A1
(43) Pub. Date: Jun. 2, 2016

(54) WINDOW PANEL FOR A VEHICULAR ELECTRIC WINDOW

(71) Applicant: Pin-Hung CHEN, Dou Liu City (TW)

(72) Inventor: Pin-Hung CHEN, Dou Liu City (TW)

(21) Appl. No.: 14/557,397

(22) Filed: Dec. 1, 2014

(51) Int. Cl. B60J 5/04

(52) U.S. Cl. CPC B60J 5/0419; B60J 5/0416

(57) ABSTRACT

A window panel for a vehicular electric window includes an inner panel, an outer panel, and a connection panel connected between the inner and outer panels. A space is defined between the inner panel, the outer panel, and the connection panel. Each of the inner panel and the outer panel includes a plurality of vents spaced at regular intervals and intercommunicated with the space. The vents of the inner panel face a panel body of the outer panel surrounding the vents of the outer panel. The vents of the outer panel face a panel body of the inner panel surrounding the vents of the inner panel. By the above structure, when the window panel is mounted to a vehicular electric window, the window panel provides a ventilation effect and a heat dissipating effect to avoid high temperature in the vehicle.

### BACKGROUND OF THE INVENTION

The present invention relates to a vehicular electric window and, more particularly, to a window panel for a vehicular electric window with a ventilation effect and a heat dissipating effect to avoid high temperature in the vehicle.

A car window is generally electrically controlled to be raised or lowered to permit convenient operation by the driver and generally includes a motor driving a main shaft to actuate the window via a transmission member. The car window is generally made of glass material. The driver closes the car doors and the car windows after leaving the car, avoiding the car and articles in the car from being stolen. However, the temperature in the interior space of the car, which is sealed and, thus, does not ventilate, rises due to exposure to the sun, which not only is detrimental to the car and the articles in the car but damages the steering wheel and the seats of the car as well as the driver. The conventional car windows are not ideal.

Thus, a need exists for a simple window panel for a vehicular electric window with a ventilation effect and a heat dissipating effect to avoid high temperature in the vehicle.

### BRIEF SUMMARY OF THE INVENTION

A window panel for a vehicular electric window according to the present invention includes an inner panel, an outer panel, and a connection panel connected between the inner and outer panels. A space is defined between the inner panel, the outer panel, and the connection panel. Each of the inner panel and the outer panel includes a plurality of vents spaced at regular intervals and intercommunicated with the space. The plurality of vents of the inner panel faces a panel body of the outer panel surrounding the plurality of the vents of the outer panel. The plurality of vents of the outer panel faces a panel body of the inner panel surrounding the plurality of vents of the inner panel.

Each of the plurality of vents of the outer panel preferably has a size no more than 2 mm in diameter.

The present invention will become clearer in light of the following detailed description of illustrative embodiments of this invention described in connection with the drawings.

### DESCRIPTION OF THE DRAWINGS

FIG. 1 is a perspective view of a window panel for a vehicular electric window according to the present invention.

FIG. 2 is a top view of the window panel for a vehicular electric window according to the present invention.

FIG. 3 is a cross sectional view of the window panel for a vehicular electric window mounted to a vehicular door, with the window panel in a lowered position.

FIG. 4 is a cross sectional view of the window panel for a vehicular electric window mounted to a vehicular door, with the window panel in a raised position.

### DETAILED DESCRIPTION OF THE INVENTION

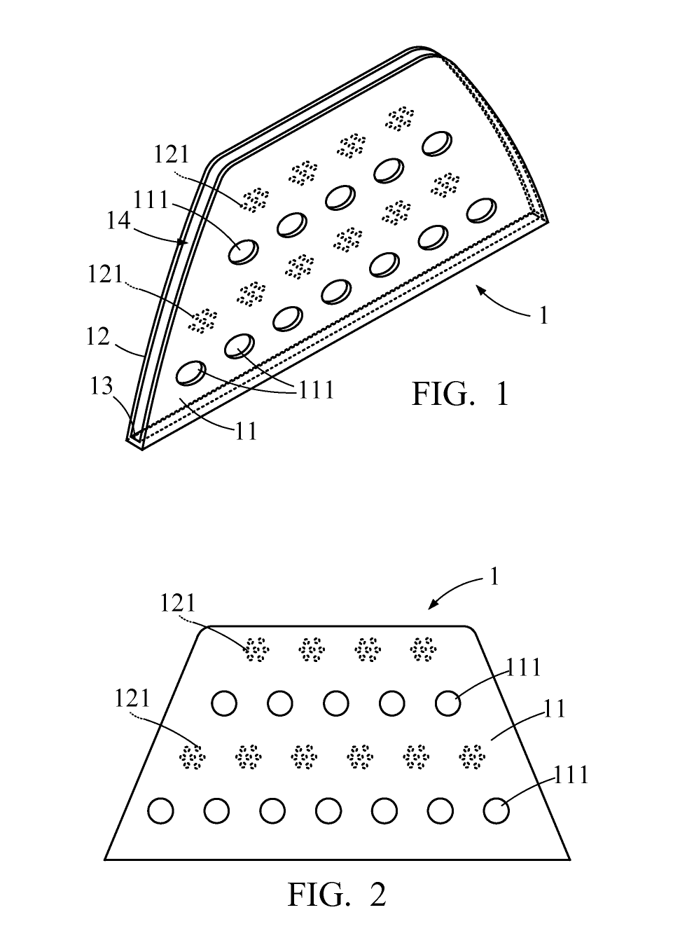

With reference to FIGS. 1 and 2, a window panel 1 for a vehicular electric window according to the present invention is made of rigid, sturdy material, such as stainless steel, and is processed by punching and bending to form a structure including an inner panel 11, an outer panel 12 substantially parallel to the inner panel 11, and a connection panel 13 connected between the inner and outer panels 11 and 12. A space 14 is defined between the inner panel 11, the outer panel 12, and the connection panel 13.

Each of the inner panel 12 and the outer panel 13 is punched to form a plurality of vents 111, 121 spaced at regular intervals and intercommunicated with the space 14. The vents 111 of the inner panel 11 are not aligned with the vents 121 of the outer panel 12. Namely, the vents 111 of the inner panel 11 face a panel body of the outer panel 12 surrounding the vents 121 of the outer panel 12, and the vents 121 of the outer panel 12 face a panel body of the inner panel 11 surrounding the vents 111 of the inner panel 11. Thus, rainwater passing through the vents 121 of the outer panel 12 into the space 14 will impact the panel body of the inner panel 11 and then drain to the outside via bottom holes 31 in a vehicular door 3 to which the window panel is mounted. With reference to FIG. 4, each vent 121 of the outer panel 12 preferably has a size no more than 2 mm in diameter, which is smaller than a size of mosquitoes and insects having the size of the mosquitoes.

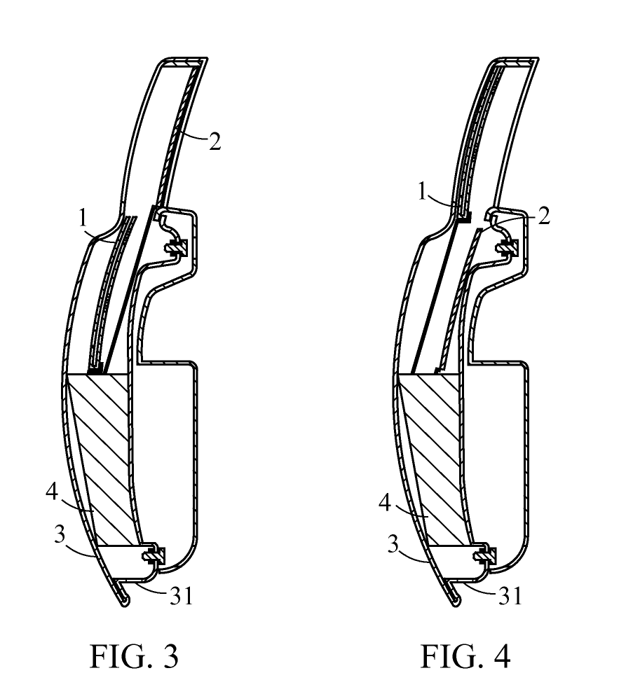

FIG. 3 is a cross sectional view of the window panel for a vehicular electric window mounted to a vehicular door 3, with the window panel 1 in a lowered position. FIG. 4 shows the window panel 1 in a raised position. The raising/lowering mechanism 4 for raising and lowering the window panel 1 can be of a type disclosed in Taiwan Patent Application No. 078203484 entitled “ELECTRIC DUAL-LAYER VEHICULAR WINDOW” in which a set of power transmission mechanism is used to operate two sets of vehicular window raising/lowering devices, or two sets of power transmission mechanisms are used to operate two sets of vehicular window raising/lowering devices respectively.

With reference to FIG. 3, when the window panel 1 according to the present invention is not in use, the raising/lowering mechanism 4 can be actuated to lower the window panel 1. With reference to FIG. 4, in use of the window panel 1 according to the present invention, the raising/lowering mechanism 4 is actuated to raise the window panel 1 and to lower a glass window 2 mounted to the vehicular door 3. Thus, the vehicle will not form a sealed interior space due to closing of the vehicular doors 3 and the glass windows 2. Furthermore, the vents 111 and 121 of the window panel 1 according to the present invention provides a ventilation effect and a heat dissipating effect to avoid high temperature of the interior space of the vehicular, which is very ideal.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A window panel for a vehicular electric window, comprising an inner panel, an outer panel, and a connection panel connected between the inner and outer panels, with a space defined between the inner panel, the outer panel, and the connection panel, with each of the inner panel and the outer panel including a plurality of vents spaced at regular intervals and intercommunicated with the space, with the plurality of vents of the inner panel facing a panel body of the outer panel surrounding the plurality of the vents of the outer panel, and with the plurality of vents of the outer panel facing a panel body of the inner panel surrounding the plurality of vents of the inner panel.

2. The window panel for a vehicular electric window as claimed in claim 1, with each of the plurality of vents of the outer panel having a size no more than 2 mm in diameter.
